(19) United States
(12) Patent Application Publication
(10) Pub. No.: US 2006/0272745 A1
(43) Pub. Date: Dec. 7, 2006

(54) Method for optimizing the debarking result of logs debarked in a debarking drum

(76) Inventor: Jouko Niinimaki, Oulu (FI)

Correspondence Address: ALIX YALE & RISTAS LLP, 750 MAIN STREET, SUITE 1400, HARTFORD, CT, 06103, US

(21) Appl. No.: 10/539,680

(22) PCT Filed: Dec. 17, 2003
(86) PCT No.: PCT/FI03/00968

§ 371 Date: Jun. 2, 2006

(30) Foreign Application Priority Data
Dec. 18, 2002 (FI) 20025065

(51) Int. Cl. A01G 23/08; B27L 1/00; B27L 3/00

(52) U.S. Cl. 144/340; 144/335; 144/4.1; 144/208.1

(57) ABSTRACT

A method for optimizing the debarking result of logs debarked in a debarking drum, especially logs of mutually approximately the same size and of the same wood species, in such a way that wood losses remain as small as possible at the same time as the control values of the debarking drum are selected to be such that the debarking degree of the logs debarked in the debarking drum is of the desired order. The amount of bark remaining on the logs in the log flow discharged from the debarking drum and the amount of damaged logs in the said log flow are measured. At the same time as the amount of bark remaining on the logs is maintained at a desired level, the amount of damaged logs is kept as low as possible in such a way that the filling degree of the debarking drum is lowered whenever the amount of damaged logs is observed to increase.

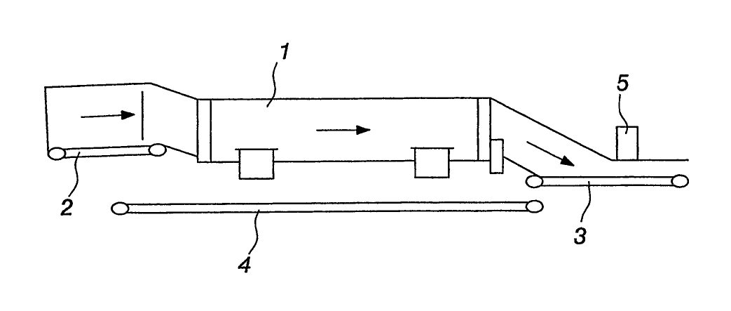

### BACKGROUND OF THE INVENTION

The invention relates to the debarking of logs in a debarking drum or the like, and in particular, to the control of the drum based on measured characteristics of the debarked logs as discharged.

Logs used in the manufacture of pulp and paper have to be debarked before processing. An excessive amount of bark in chemical pulp may lead to capacity and deposition problems, and in mechanical pulp even a small amount of bark may cause problems regarding the quality of the product.

Drum debarking is a simple system where the degree of debarking and wood losses are crucial factors affecting the technical and economical performance of a pulp or paper mill. In conventional drum debarking, wood losses may amount to 1-5% or even higher, which should be taken into account from the economical viewpoint. It is possible to lower these expenses through appropriate control of the wood yard and debarking operations, but often the level of automation is very low at the debarking plant. One reason for the low level of automation is the lack of reliable and economically priced measuring methods for measuring the performance of the debarking process.

A typical known approach for measuring the performance of wood handling operations is to measure the wood content on the bark conveyor as wood loss and the bark content on the logs after debarking as the measure of residual bark. The measurements are carried out by means of a CCD or linear camera, and the information desired is obtained through image analysis. Certain problems are involved in the present measuring arrangement.

In all debarking drums, the greatest wood losses take place at the end of the drum, after almost all the bark has been removed. If the bark conveyor moves in the opposite direction with respect to the log flow, bark will readily cover the wood particles, thus making direct measurement of wood loss directly from the conveyor difficult. In such a case, the measurement system must take the material for sampling from the conveyor, which makes measurement slower and more expensive than in direct systems.

In addition to the proper placement of the measuring device being difficult, the instrumentation costs are high in the current system. This is due to the method, in which wood loss is measured from the bark conveyor and residual bark-content from the log conveyor before the chipper, which means that two separate devices are required to measure wood loss and bark content.

Wood losses take place when small pieces of wood are detached from a log and pass from the drum, through the bark apertures, to the bark conveyor. The pieces are typically not detached from the sides of a log but rather from the log ends. Most logs thus become rounded at the ends. If we suppose that each log is fully rounded, we can calculate a kind of theoretical wood loss. Since the average rounding is not perfect, the result of the calculation can in practice be considered as the maximum wood loss.

In this way, wood losses indicated by calculations are about 0.5-3.1%, but the wood losses encountered in practice are considerably higher. This shows that when logs are subjected to breakage, wood losses are caused rather through cutting and crushing than through the rounding of log ends.

### SUMMARY OF THE INVENTION

The object of the invention is to provide a method for optimizing the debarking result of logs debarked in a debarking drum.

This object is achieved in that the amount of bark remaining on the logs in the log flow discharged from the debarking drum and the amount of damaged logs in the log flow are measured, and that at the same time as the amount of bark remaining on the logs is maintained at a desired level, the amount of damaged logs is kept as low as possible, in such a way that the filling degree of the debarking drum is lowered whenever the amount of damaged logs is observed to increase.

The novel and inventive aspect of the invention disclosed in the main claim is specifically the fact that it has now been found that the debarking drum can be controlled by measuring the amount of damaged logs in the log flow discharged from the debarking drum and by maintaining it as low as possible by lowering the filling degree of the debarking drum whenever the amount of damaged logs is found to increase. The invention is based precisely on the realisation that the amount of broken logs can be used to control the debarking drum. A solution of this kind has neither been suggested nor used before. The observation of damaged logs does not, however, suffice alone, but the debarking degree of the logs coming from the debarking drum must simultaneously also be observed and maintained at the desired level, in order for the debarked logs to meet the requirements set for debarking.

The measures required for bringing the debarking degree of the logs debarked in the debarking drum to the desired level are fully known. The debarking degree is selected for the debarked logs in accordance with the requirements set in each case.

The tests performed have shown that a reliable control system in drum debarking can be direct and based on only one unit of measurement, whereby the amount of bark is measured as one performance factor and the proportion of damaged or broken logs as a factor preceding wood loss.

Wood losses are affected by a number of parameters. The most important of these are the properties of the logs (e.g. wood species, diameter, density, length, degree of decay), the manner of loading of the debarking drum, and the capacity and speed of rotation of the debarking drum. The properties of the wood affect the tendency to break, whereas the operational parameters affect the intensity of the conditions. If wood loss due to the wearing of the end is accepted and emphasis is placed on minimising wood breakage, the principle of minimum breakage can be used. The principle of minimum breakage refers to conditions with the minimum tendency to break the logs. To achieve these conditions, it is possible to vary either the filling degree or speed of rotation of the drum.

The tests performed indicate that an increase in the speed of rotation of the drum increases the amount of broken logs. The amount of broken logs is proportional to the debarking power. This is because the energy is dissipated to wood-wood and wood-drum contact points. This is true only in cases where the properties of the wood are relatively constant. Tests show that the variables for the debarking drum can be selected in such a way that the debarking of the logs will take place efficiently without breaking the logs. In such a case, the operational parameters should be selected so that a greater amount of weaker contacts will take place that can be achieved by a higher speed of rotation and lower degree of filling. This means that more contacts will take place between the drum and the log, which causes greater rounding of the ends, but the impacts between the logs are weaker, which in turn reduces the probability of the logs being cut or broken. If logs having a low length-diameter ratio (do not break readily) are debarked, the wearing of the log ends induces more wood loss than breakage. In this case, a lower speed of rotation and a higher degree of filling should be used to minimise drum-log contacts and maximise the power of log-log contacts.

The principle presented above provides a control strategy for debarking different sizes and species of logs separately, but not for debarking mixtures of thinner and thicker logs. Such mixtures should be avoided because they always cause high wood losses. According to the strategy presented, if the logs remain intact in the drum, the lowest speed of rotation and the highest degree of filling are applied. If breakage or cutting is observed, the degree of filling should be lowered at the same time as the debarking power required is compensated by an increased speed of rotation of the drum.

This control method can be based on only one direct measurement point located on the debarked logs conveyor. This measuring device should measure the amount of bark, the amount of broken logs and possibly even the roundness of the logs, and control the speed of rotation of the drum and the filling degree accordingly.

### BRIEF DESCRIPTION OF THE DRAWINGS

The invention is described in greater detail in the following, with reference to the accompanying drawing, which shows diagrammatically the debarking drum provided with the measuring unit used in the method according to the invention.

### DESCRIPTION OF THE PREFERRED EMBODIMENT

In the drawing, reference numeral 1 denotes the debarking drum, from one end of which the logs to be debarked are fed in by means of a feed conveyor 2 and from the other end of which come out the debarked logs on a discharge conveyor 3.

The rotation of the drum 1 causes the logs to rub against one another, whereby the bark detaches from their surface and is discharged from the drum 1 through the bark apertures (not shown) on its shell, onto a belt conveyor 4 below the drum 1. At the same time, however, depending on the process controls, more or less of the actual wood material detaches from the logs, the wood material accounting for the wood loss when it discharges with the bark through the bark apertures.

The measuring unit arranged above the discharge conveyor 3 is marked by reference numeral 5. It is used in the method according to the invention, where it measures the amount of bark remaining on the logs in the log flow discharged from the debarking drum 1, and the amount of damaged logs in the said log flow. A device making possible this operation is of a type known as such and it is, therefore, not necessary to describe it in any greater detail in this connection. By maintaining the amount of bark remaining on the logs at a desired level, the debarking efficiency of the debarking drum 1 is controlled in such a way that the amount of damaged logs is as small as possible.

On the basis of the results given by the measuring unit 5, the speed of rotation and filling degree of the debarking drum are controlled, or the measuring unit controls these automatically. Thus, the debarking result of the logs to be debarked can be optimized so that the debarking degree is of the desired order, and at the same time the wood losses are as low as possible.

From the prior art is known a device which can be used to measure, among other things, the debarking degree of debarked logs. The same device can also be applied to the method according to the invention, whereby also the amount of damaged logs is measured with the device. It should again be emphasised that it has not occurred to anyone before that the amount of damaged logs could be measured and the debarking drum be controlled on the basis of the measurement. Ever since this was realised, it has been clear that the measurement itself can be carried out by means of a known device.

In the solution according to the invention, when the amount of damaged logs is observed to be increasing, which thus indicates that the wood losses in the debarking drum have increased, measures known as such are taken to reduce wood losses. These measures primarily include lowering of the filling degree. To compensate the debarking power required, the speed of rotation of the drum may in addition be increased. These measures are in principle the same irrespective of the size of the logs handled in the drum.

In the solution according to the invention, the amount of damaged logs in the flow of logs discharged from the debarking drum refers primarily to the amount of logs shorter than the expected value, in other words the amount of cut logs, which is thus used as a control variable. However, in this connection the amount of damaged logs also refers to the amount of logs narrower than the expected value, and the amount of logs deviating from the expected cylindrical geometry of logs. The amount of damaged logs can also be measured by means of the image formed of each log and the cylindrical geometry. Depending on the logs handled, each of these can be used as a control variable.

The following can be stated to summarise. Logs used in the manufacture of pulp and paper have to be debarked before processing. Drum debarking as a unit process is a complicated system, where the degree of debarking and wood losses are crucial factors affecting the technical and economical performance of a pulp or paper mill. The properties of wood, the speed of rotation of the drum and the filling degree are the most significant debarking variables affecting the degree of debarking or wood losses. It is, however, not possible to simulate wood losses by means of these main parameters, because there are many disturbing variables, and some, such as the properties of wood and the filling degree, that are too difficult to measure. The invention provides a new method for controlling the debarking drum. Based on the fact that log breakage has a substantial effect on wood losses, it is suggested according to the invention that the principle of minimum breakage be used as a control basis. The principle of minimum breakage means that an optimal debarking result can be achieved by using maximal debarking efficiency, from which follows a minimum amount of broken logs. In the case of rugged logs, the maximum filling degree should be used together with the minimum speed of rotation in order to prevent the wearing of the log ends. On the other hand, in the case of long, thin logs, which are cut or otherwise break easily, a large number of weak wood contacts results in the lowest wood loss. This can be achieved by keeping the drumming power constant and by increasing the speed of rotation and simultaneously lowering the filling degree.

The term “debarking drum” used above in the specification and below in the claims should, in this connection, be understood in a wide sense to cover—in addition to conventional rotating debarking drums—also such debarking apparatuses in which the logs are caused to move in a similar manner as in a rotating debarking drum by using, for example, rotating disc shafts and disc shafts possibly having cogged discs.

1. A method for optimizing the debarking of logs fed to a rotating debarking drum, such that wood losses remain small while control values of the debarking drum are selected such that the amount of bark remaining on the logs including damaged logs debarked in the debarking drum is maintained at a target value, wherein the improvement comprises that the amount of bark remaining on the logs in the log flow discharged from the debarking drum and the amount of damaged logs in the said log flow are measured, and that at the same time as the amount of bark remaining on the logs is maintained at said target value, the amount of damaged logs is kept low, in such a way that the filling degree of logs fed to the debarking drum is reduced in response to a measured increase in the amount of damaged logs.

2. A method as claimed in claim 1, wherein the amount of damaged logs is measured as an amount of logs shorter than the expected length of said fed logs.

3. A method as claimed in claim 1, wherein the amount of damaged logs is measured as an amount of logs narrower than the expected value of said fed logs.

4. A method as claimed in claim 1, wherein the amount of damaged logs is measured as an amount of logs deviating from the expected cylindrical geometry of said fed logs.

5. A method as claimed in claim 4, wherein the amount of damaged logs is measured by comparing the image formed of each log and the cylindrical expectancy geometry.

6. A method as claimed in claim 1, wherein the measurement is carried out as direct measurement at one point of in the log flow discharged from the debarking drum.

7. A method as claimed in claim 1, wherein the amount of damaged logs increases, the degree of filling is reduced at the same time as the speed of rotation of the drum is increased.

8. The method as claimed in claim 1, wherein the fed logs are approximately the same size and of the same wood species.

9. The method as claimed in claim 7, wherein the fed logs are approximately the same size and of the same wood species.

10. A method for optimising the debarking of logs fed to a debarking device having a rotating drum and a fill capacity, comprising: feeding logs of approximately the same size and same species to the debarking device; controlling the feed rate of the logs to the debarking device; controlling the speed of rotation of the rotating drum; measuring the degree of debarking on the discharged logs including logs damaged during debarking; measuring changes in the extent of logs damaged during debarking; and in response to the measurements of the degree of debarking and the extent of logs damaged during debarking, decreasing (increasing) the feed rate as the measured changes in the extent of damaged logs increases (decreases).

11. The method as claimed in claim 10, wherein the speed of rotation of the drum is controlled to increase at the same time the feed rate is controlled to decrease.

12. The method as claimed in claim 10, wherein the measurement of changes in the extent of logs damaged during debarking is performed at a discharge chute downstream of the debarking drum and the feed rate of the logs is controlled to adjust the fill level of logs in the debarking device commensurate with the measured change in the extent of damaged logs.

13. The method as claimed in claim 12, wherein the speed of rotation of the drum is controlled to increase as the feed rate is controlled to decrease, whereby control of the feed rate and the speed of rotation maintains the degree of debarking at a target value.
